(19) United States
(12) Patent Application Publication
(10) Pub. No.: US 2026/0056536 A1
(43) Pub. Date: Feb. 26, 2026

(54) MINIMALLY SUPERVISED LEARNING FOR DETERMINING CAUSES OF OUTLYING DATA POINTS

(71) Applicant: Delta Design, Inc., Poway, CA (US)

(72) Inventor: Charles Lincoln Parker, Lake Bluff, IL (US)

(21) Appl. No.: 19/303,234

(22) Filed: Aug. 18, 2025

Related U.S. Application Data
(60) Provisional application No. 63/685,178, filed on Aug. 20, 2024.

(51) Int. Cl. G05B 19/418

(52) U.S. Cl. CPC G05B 19/41875; G05B 2219/34082; G05B 2219/45031

(57) ABSTRACT

A system may identify anomalous output among a plurality of outputs at a process step in the manufacturing process. A system may receive manufacturing attributes associated with each of the plurality of outputs including the anomalous output. A system may build, using a machine learning model, at least one isolation tree model comprising a plurality of parent nodes each corresponding to a split condition of one of the manufacturing attributes and a leaf node corresponding to the anomalous output, wherein each of the parent nodes of the at least one isolation tree model is associated with a manufacturing attribute directly leading to the anomalous output.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57

This application claims priority to Provisional Patent Application No. 63/685,178, titled “MINIMALLY SUPERVISED LEARNING FOR DETERMINING CAUSES OF OUTLYING DATA POINTS,” and filed Aug. 20, 2024, the content of which is incorporated by reference herein in its entirety.

### TECHNICAL FIELD

The disclosed technology relates generally to semiconductor fabrication and metrology methods and apparatuses. More specifically, it relates to techniques and systems for identifying causes of anomalous output of semiconductor fabrication process.

### BACKGROUND

In semiconductor manufacturing, complex structures can be fabricated using sequences including thin film deposition, photolithography and etching. Complex structures can be fabricated using lithography to define regions of a mask layer, e.g., a photoresist layer or a hardmask layer, to be patterned by exposure to light, removing portions of the mask layers to define a template pattern with small feature sizes, removing portions of an underlying layer using the template pattern by applying an etchant, and repeating these steps many times for various layers of a device. Various tools can be used in semiconductor manufacturing, including processing tools and metrology tools.

Due to the complex nature and numerous steps of semiconductor manufacturing, process anomalies can be difficult to detect in-line or isolate the step(s) correlated therewith. Further, due to cost, only a sample of wafers may be inspected at a subset of process steps. As a result, by the time an anomalous output is detected at a certain process step or in a final product, it can be difficult to determine the cause of or identify the step associated with the anomalous output (e.g., a semiconductor device with one or more features that do not meet specifications) from semiconductor manufacturing processes. This can cause delays in semiconductor manufacturing while the cause of the anomalous output is identified and corrected.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

In one aspect, a method of associating an anomalous output of a semiconductor manufacturing process with a manufacturing attribute of the manufacturing comprises identifying the anomalous output among a plurality of outputs at a process step in the manufacturing process, receiving manufacturing attributes associated with each of the plurality of outputs including the anomalous output, and building, using a machine learning model, at least one isolation tree model comprising a plurality of parent nodes each corresponding to a split condition of one of the manufacturing attributes and a leaf node corresponding to the anomalous output. Each of the parent nodes of the at least one isolation tree model is associated with a manufacturing attribute directly leading to the anomalous output.

In another aspect, non-transitory computer readable storage media storing instructions that when executed by a system of one or more processors, cause the one or more processors to identify anomalous output among a plurality of outputs at a process step in a semiconductor manufacturing process, receive manufacturing attributes associated with each of the plurality of outputs including the anomalous output and build, using a machine learning model, at least one isolation tree model comprising a plurality of parent nodes each corresponding to a split condition of one of the manufacturing attributes and a leaf node corresponding to the anomalous output. Each of the parent nodes of the at least one isolation tree model is associated with a manufacturing attribute directly leading to the anomalous output.

In another aspect, a system for associating an anomalous output of a semiconductor manufacturing process with a manufacturing attribute of the manufacturing process comprises one or more processor; and non-transitory computer readable storage media storing instructions that when executed by the one or more processors, cause the one or more processors to identify anomalous output among a plurality of outputs at a process step in a semiconductor manufacturing process, receive manufacturing attributes associated with each of the plurality of outputs including the anomalous output, and build, using a machine learning model, at least one isolation tree model comprising a plurality of parent nodes each corresponding to a split condition of one of the manufacturing attributes and a leaf node corresponding to the anomalous output. Each of the parent nodes of the at least one isolation tree model is associated with a manufacturing attribute directly leading to the anomalous output.

### BRIEF DESCRIPTION OF THE DRAWINGS

Embodiments of this disclosure will be described, by way of non-limiting examples, with reference to the accompanying drawings.

FIG. 1 is a schematic illustration of an analysis computing system used to analyze a semiconductor manufacturing process, according to various aspects of the present disclosure.

FIG. 2 shows an example of one machine learning technique that can be used to detect anomalous data.

FIG. 3 shows an example of another machine learning technique that can be used to detect anomalous data.

FIG. 4 is an exemplary process of determining causes of an anomalous output of a manufacturing process, according to various aspects of the present disclosure.

FIG. 5 is an exemplary process of a subroutine for building an isolation tree model, according to various aspects of the present disclosure.

### DETAILED DESCRIPTION

The following detailed description of certain embodiments presents various descriptions of specific embodiments. However, the innovations described herein can be embodied in a multitude of different ways, for example, as defined and covered by the embodiments. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the illustrated elements. Further, some embodiments can incorporate any suitable combination of features from two or more drawings.

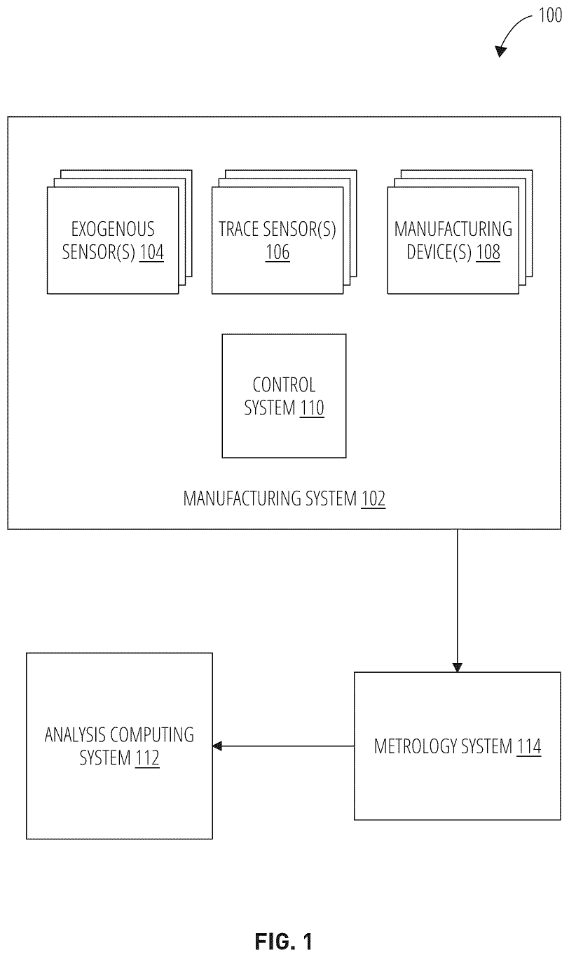

FIG. 1 is a high-level schematic illustration of a system in which an analysis computing system is used to analyze a semiconductor manufacturing process, according to various aspects of the present disclosure. As shown, the system 100 includes a manufacturing system 102, an analysis computing system 112, and a metrology system 114.

In some embodiments, the manufacturing system 102 may represent any system or collection of sub-systems that can perform at least a portion of a manufacturing process such as a semiconductor manufacturing process. The manufacturing system 102 includes one or more manufacturing devices 108 that perform the physical steps of the manufacturing process, as well as a control system 110 that provides control inputs to the manufacturing devices 108. In a semiconductor manufacturing process, some examples of manufacturing devices 108 may include, but are not limited to, a thin film deposition device, a photolithography device, an etching device, an overlay correction device, a chemical mechanical planarization device, an annealing device and a cleaning device, to name a few. Some examples of semiconductor manufacturing process steps performed by such devices include, but are not limited to, thin film deposition, photolithography, etching, overlay correction, annealing, cleaning and chemical mechanical planarization.

During operation of the manufacturing devices 108, one or more exogenous sensors 104 and/or one or more trace sensors 106 generate data that may be transmitted to and consumed by the analysis computing system 112. The trace sensors 106 may be installed as part of a manufacturing device for, e.g., in situ monitoring or measurements. In some embodiments, the trace sensors 106 that perform in-situ monitoring or measurements may include one or more sensors that measure characteristics of a manufacturing device 108 or an action performed by a manufacturing device 108. Examples of characteristics measured by trace sensors 106 in these embodiments include, but are not limited to, one or more of heating element zone or wafer temperatures; mass flow rates of inlet and/or exhaust gas or liquid streams; chamber pressures; power supply currents, voltages, powers, and/or frequencies; exposure parameters lithography; pad pressure and rotation parameters for chemical mechanical polishing or optical emission spectroscopy wavelength bands of exhaust streams.

In some embodiments, the exogenous sensors 104 may include one or more sensors that measure characteristics of the environment in which the manufacturing devices 108 are operating that may affect the condition of an output of the manufacturing devices 108 for one reason or another. Examples of characteristics that may be measured by the exogenous sensor 104 include, but are not limited to, one or more of a timestamp of an action taken by a manufacturing device 108, an ambient temperature, or a relative humidity. In some embodiments, apriori values may also be collected and reported by the exogenous sensors 104 and/or the trace sensors 106. Examples of apriori values may include, but are not limited to, one or more of a wafer number, a chamber accumulation counter value, a hot plate identifier, and a measurement value from a previous process step.

Once the manufacturing devices 108 perform one or more steps on an input (e.g., a wafer), the metrology system 114 may measure an output of the manufacturing devices 108 (e.g., an output wafer) to analyze the accuracy of the operations performed by the manufacturing devices 108. One or more metrology sensors may be installed as part of a metrology device, for e.g., ex situ monitoring or measurements. In some other embodiments, the metrology sensors that perform ex situ monitoring or measurements may include one or more sensors that measure physical, electrical or optical characteristics of the result of a process performed by manufacturing device 108 or an action performed by a manufacturing device 108. Examples of characteristics measured by the metrology sensors in these embodiments include, but are not limited to one or more of a thickness, film uniformity (e.g., within-wafer thickness uniformity), film stress (e.g., wafer bow), feature dimension (e.g., feature width, etc.), feature morphology (e.g., feature angle, etc.), optical parameters (e.g., refractive index, etc.) and defect profile (e.g., particles, etc.), to name a few. The metrology system 114 may generate one or more measured metrology values based on the output, including but not limited to one or more of a thickness, a stress, a refractive index, a sidewall angle, and an etch critical dimension. The measured metrology values and/or values from the sensors may then be provided to the analysis computing system 112.

In manufacturing processes such as the semiconductor manufacturing process illustrated in FIG. 1, one persistent problem is determining why a particular manufacturing output, such as a wafer, is anomalous (e.g., not in compliance with one or more specifications), or at least isolate a manufacturing step associated with the anomaly. There are a multitude of adjustable settings on the manufacturing devices 108, and the outputs of manufacturing devices 108 are often affected by both the state of the manufacturing devices 108 and various exogenous factors, as reported by the trace sensors 106, exogenous sensors 104 and the metrology system 114. That said, because there can be large numbers of variables reported by the sensors, and large numbers of variables reported by the metrology system 114, it can be computationally intractable to determine the cause of a particular anomaly for all of the reported data. Thus, there is a need for automated and computationally economical techniques that are capable of explaining anomalies in manufacturing outputs such as semiconductor wafers.

In some instances, one or more anomaly detection models using machine learning techniques such as isolation forests or isolation trees can be used to determine the cause of a particular anomaly. In such techniques, a tree can be created out of all of the data (e.g., sets of measurements from the metrology system 114 for a plurality of wafers), and a leaf node containing the anomalous data is determined. Techniques for analyzing the tree, such as Shapley additive explanation (SHAP) values, may be used to determine an explanation for why the anomalous data was sorted as it was. However, some of these techniques can be inefficient for several reasons. For example, these techniques fully process all of the data, including both anomalous and normal data, in order to detect the anomalous data, thereby consuming very high computational resources. Aspects of this disclosure described improved anomaly detection using machine learning techniques that can detect anomalous output with increased efficiency.

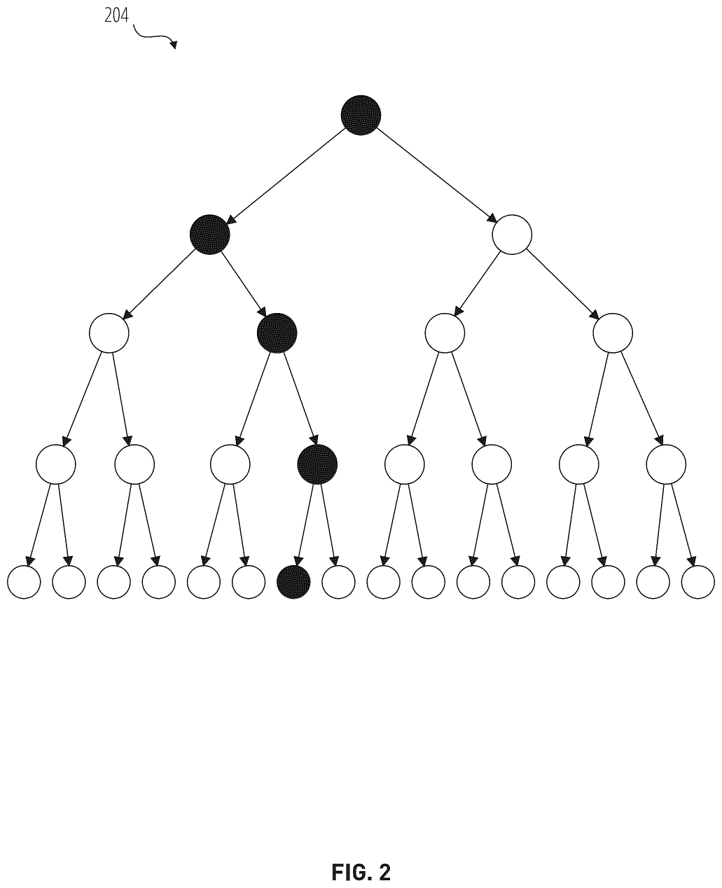

FIG. 2 shows an example of one machine learning technique that can be used to detect anomalous data. In the example, a plurality of data points (e.g., sets of measurements of wafers from a metrology system 114) are organized into an isolation tree 204. A balanced binary tree is shown for ease of discussion, but an actual isolation tree 204 may include branches of different lengths and/or more than two children for each node. Each node in the tree divides the data points based on a threshold value for a feature of the sets of measurements, and the length from the root node to a leaf node containing a single set of measurements (e.g., a data point for a given wafer) is an indication of how anomalous the data point is. In some implementations, many isolation trees, such as the isolation tree 204, can be built with random selection of features and threshold values for each node in order to create an isolation forest, and the average path lengths can be used to determine the anomalous data point. The nodes illustrated in black contain the anomalous data point in the illustrated example.

Once the anomalous data point is found by constructing the isolation tree/forest, SHAP values (or other comparable techniques) can be used to help determine which features contributed to the anomalous nature of the data point. While this may produce a result, the difficulty in producing a result can increase exponentially as the complexity of the problem increases (e.g., when the variables considered increase). Since manufacturing processes, such as semiconductor manufacturing, often result in very large numbers of data points and measurements/features per data point, the problem quickly becomes intractable when an isolation forest is based on isolation trees like isolation tree 204.

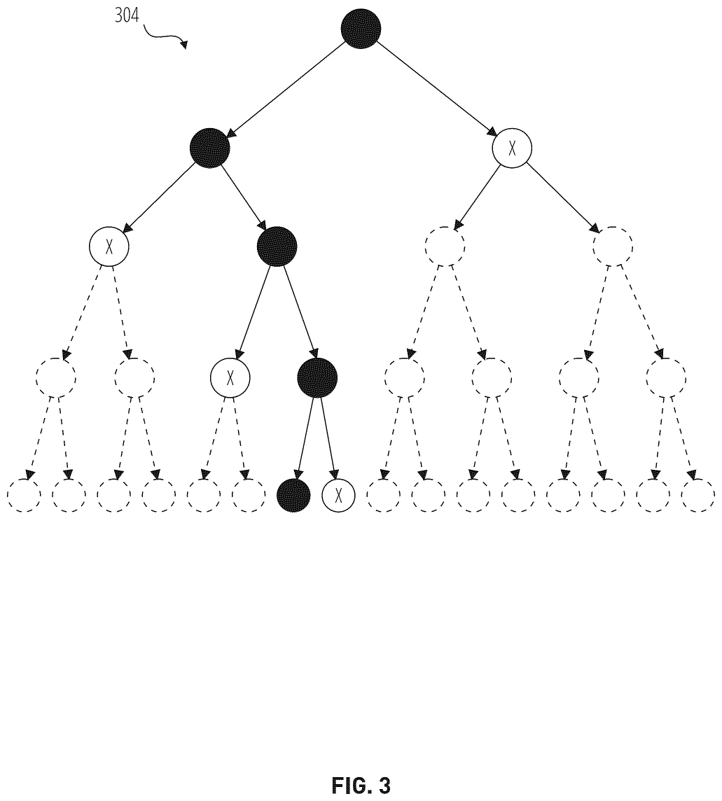

FIG. 3 illustrates an improved technique that uses isolation trees/forests to explain anomalies according to various aspects of the present disclosure. Since the output of a semiconductor manufacturing process can be measured (e.g., using the metrology system 114), the anomalous set of measurements or data point can be known (e.g., by virtue of the metrology system 114 detecting one or more flaws in the wafer). As such, the entire isolation tree/forest illustrated in FIG. 2 does not need to be constructed in order to find the anomalous data point. For instance, at each level of the tree, the sets of measurements can be split into child nodes as was done for isolation tree 204, but instead of processing all of the child nodes, the child node that includes the anomalous data point can be processed without processing at least some of the other child nodes, e.g., all of the other child nodes. This can result in the sparse isolation tree 304 illustrated in FIG. 3. In the illustrated example, the solid line nodes indicate nodes that are determined, and the nodes with Xes and dashed lines indicate nodes that are not processed further. As such, instead of an isolation tree 204 with 31 nodes that are processed as illustrated in FIG. 2, the illustrated sparse isolation tree 304 only includes 5 nodes that are processed. SHAP values may then still be calculated based on these five nodes, and used to help explain the anomalous data point. By only processing the nodes with the known to-be anomalous data point, the total size of the tree can be reduced by orders of magnitude from having to build the whole tree, thus making the process tractable and useful for explaining anomalies.

In some embodiments, some of the child nodes that do not include the anomalous data point can also be processed (e.g., some of the nodes labeled with Xes and some of the child nodes therefrom). In some instances, the increase in total nodes considered can improve the estimated average depth of an unbuilt subtree, which can factor in the overall analysis of the isolation tree (e.g., using SHAP values or other suitable techniques). The increase in total nodes considered can have a tradeoff in total computation time (e.g., an increase in the process time needed to build the isolation tree). Various techniques can be used to determine which child nodes that do not include the anomalous data are processed. In some implementations only a set number of child nodes (e.g., one, two, four, etc.) with non-anomalous data points following a split condition that includes the anomalous data points are processed. For example, all the nodes labeled with Xes may be processed, all the nodes labeled with Xes and the child nodes directly connected to the nodes labeled with Xes may be processed, or another arrangement of nodes with non-anomalous data points may be processed. In one implementation, only the node with non-anomalous data points from the first split condition in an isolation tree is processed.

Table 1 provides a computation efficiency comparison between building a full isolation tree, such as isolation tree 204, and a sparse isolation tree, such as sparse isolation tree 304. As shown in Table 1, the time it takes to build a sparse isolation tree is significantly reduced when compared to the time it takes to build a full isolation tree. Further, as the dataset considered scales up, the gap between the time it takes to build a full isolation tree and the time it takes to build a sparse isolation tree increases, improving the benefits further as datasets increase.

TABLE 1

| | | Process Time for | Process Time for | | |
|---|---|---|---|---|---|
| | | Full Isolation | Sparse Isolation | | Time |
| Dataset Size | | Tree (sec.) | Tree (sec.) | Speedup | Reduction |
| 100,000 | rows | 4.7133 | 0.3442 | 13.96x | 92.7% |
| 250,000 | rows | 12.5861 | 0.8466 | 14.87x | 93.3% |
| 1,000,000 | rows | 55.9506 | 3.0443 | 18.62x | 94.6% |

While FIG. 2 and FIG. 3 illustrate the use of isolation trees/forests to explain anomalies, a skilled artisan would appreciate that the concepts described herein can be applicable beyond isolation trees/forests or other tree-shaped models to other ablated learning models. For example, in some implementations, local interpretable model-agnostic explanations (LIME) based model learning, local linear models, and/or other suitable learning models may be used.

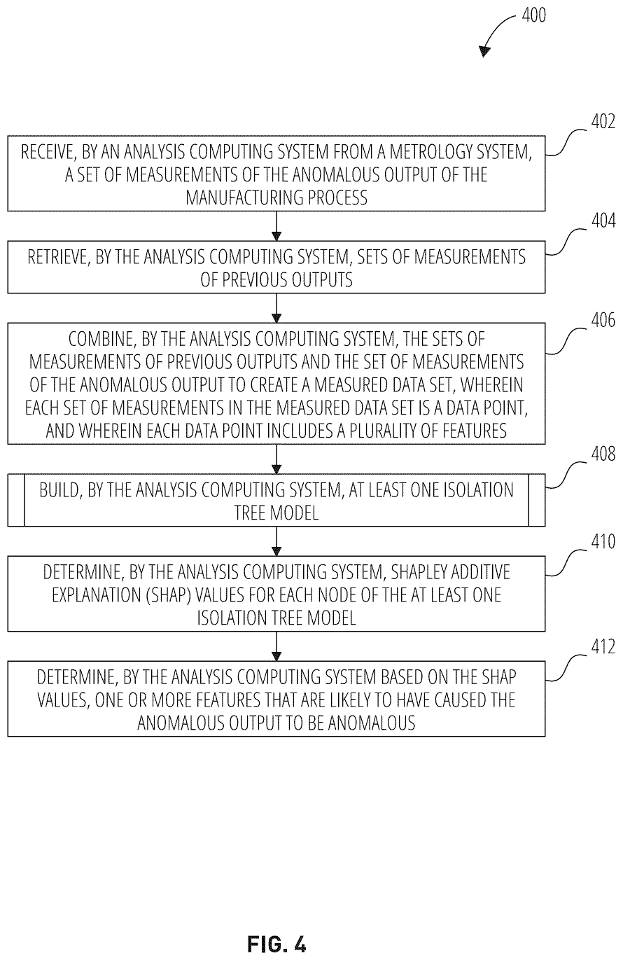

FIG. 4 is a flowchart that illustrates a non-limiting example embodiment of a technique for determining causes of an anomalous output of a manufacturing process, according to various aspects of the present disclosure.

In block 402, an analysis computing system receives, from a metrology system, a set of measurements of the anomalous output of the manufacturing process. Upon building an isolation tree as described in FIG. 3, for e.g., the set of measurements in the block 402 can be represented by the marked leaf node. The measurements can include manufacturing attributes associated with outputs from a process step in a semiconductor manufacturing process, as measured by the metrology system. As described herein, examples of the measurements received from metrology sensors of the metrology system can include one or more of a thickness, film uniformity (e.g., within-wafer thickness uniformity), film stress (e.g., wafer bow), feature dimension (e.g., feature width, etc.), feature morphology (e.g., feature angle, etc.), optical parameters (e.g., refractive index, etc.) and defect profile (e.g., particles, etc.), to name a few. The measurements received by the computing system in block 402 includes the anomalous output. The outputs from the process step can be identified as being anomalous by the analysis computing system, e.g., based on a physical attribute or an electrical attribute measured using a sensor installed on a metrology or test equipment.

In block 404, the analysis computing system retrieves sets of measurements of previous outputs. The previous outputs can be outputs of the metrology system at steps leading up to, but not including, the step at which the set of measurements of the anomalous output of the block 402 are collected. Upon building an isolation tree as described in FIG. 3, for e.g., the measurements of the previous outputs in the block 404 can be represented by the parent nodes leading up to the marked leaf node. The measurements of previous outputs can also include manufacturing attributes associated with other outputs from process steps in the semiconductor manufacturing process (e.g., those associated with other, non-anomalous semiconductor wafers). In some embodiments, the analysis computing system may retrieve the sets of measurements from a data store of previous measurements, and may retrieve relevant previous measurements (e.g., measurements that share a feature with the set of measurements of the anomalous output, such as using the same recipe, matching data collected, the same worker running a manufacturing device 108, etc.). Due to the increase in speed provided by the techniques disclosed herein, this just-intime creation of an isolation tree/forest with relevant data is possible, whereas it would be intractable using previous techniques of training the isolation tree/forest.

In block 406, the analysis computing system combines the sets of measurements of previous outputs and the set of measurements of the anomalous output to create a measured data set, wherein each set of measurements in the measured data set is a data point, and wherein each data point includes a plurality of features.

At subroutine block 408, a subroutine (such as subroutine 500) is performed wherein the analysis computing system builds at least one isolation tree model. In various embodiments, the isolation tree includes a plurality of parent nodes, where each parent node corresponds to a split condition of one of the manufacturing attributes, and a leaf node corresponding to the anomalous output. The split condition of each of the manufacturing attributes can be randomly determined (e.g., using a machine learning model).

In some of these embodiments, to build the at least one isolation tree model, the analysis computing system creates two or more parent nodes based on a comparison of a first measurement of the manufacturing attribute to a threshold. The threshold can also be randomly determined or generated. The analysis computing system can then omit from further consideration those of the two or more parent nodes that do not contain the first measurement and create leaf nodes (also referred to as child nodes) from a remaining parent node. Each leaf node can be based on a comparison of a subsequent measurement of the manufacturing attributes to a subsequent threshold (e.g., a randomly generated subsequent threshold). The child nodes that do not contain the subsequent measurement can be omitted from further consideration. The analysis computing system can repeat the creation of child nodes until all measurements in the manufacturing attributes are associated with a nod of the isolation tree model.

In block 410, the analysis computing system assigns values to each node of the isolation tree model. For example, the analysis computing system can determine Shapley additive explanation (SHAP) values for each node of the at least one isolation tree model. In block 412, the analysis computing system determines, based on the SHAP values, one or more features that are likely to be associated with manufacturing attributes that are associated with to have anomalous output. The determined features may be presented on a display of the analysis computing system, or otherwise provided for use in controlling the manufacturing system 102.

In various embodiments, the analysis computing system can build an isolation forest (e.g., multiple isolation tree models) that are used to determine the one or more features that are likely to be associated with the manufacturing attributes that are associated with to have anomalous output. The analysis computing system may track the path length of each isolation tree model (e.g., track the number of nodes between the parent node and the last child node). The analysis computing system can continue to generate isolation tree models in the isolation forest until the path length (e.g., the average path length) converges.

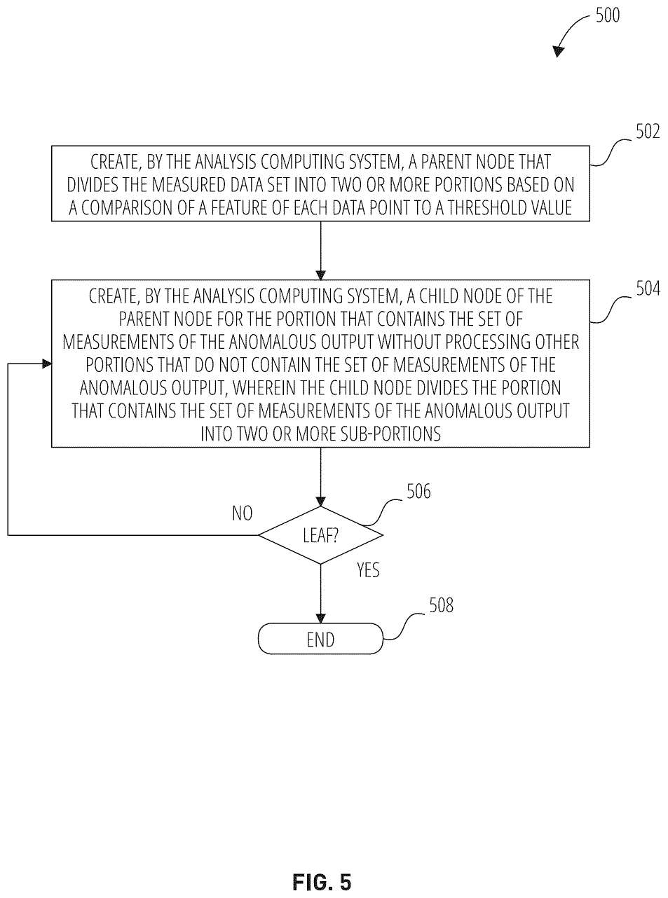

FIG. 5 is a flowchart that illustrates a non-limiting example embodiment of a subroutine for building an isolation tree model, according to various aspects of the present disclosure. In block 502, the analysis computing system creates a parent node that divides the measured data set into two or more portions based on a comparison of a feature of each data point to a threshold value. In block 504, the analysis computing system creates a child node of the parent node for the portion that contains the set of measurements of the anomalous output without processing other portions that do not contain the set of measurements of the anomalous output, wherein the child node divides the portion that contains the set of measurements of the anomalous output into two or more sub-portions.

The subroutine 500 then advances to a decision block 506. If the set of measurements of the anomalous output is within a leaf node of the isolation tree model (e.g., the set of measurements of the anomalous output is alone in a child node), then the result of decision block 506 is YES, and the subroutine 500 advances to a done block 508 and returns control to its caller. Otherwise, the result of decision block 506 is NO, and the subroutine 500 returns to block 504 to create further child nodes.

### Additional Examples I

1. A computer-implemented method of determining causes of an anomalous output of a manufacturing process, the method comprising:
   receiving, by an analysis computing system from a metrology system, a set of measurements of the anomalous output of the manufacturing process;
   retrieving, by the analysis computing system, sets of measurements of previous outputs;
   combining, by the analysis computing system, the sets of measurements of previous outputs and the set of measurements of the anomalous output to create a measured data set,
   wherein each set of measurements in the measured data set is a data point, and wherein each data point includes a plurality of features;
   building, by the analysis computing system, at least one isolation tree model by performing actions comprising:
      creating, by the analysis computing system, a parent node that divides the measured data set into two or more portions based on a comparison of a feature of each data point to a threshold value; and
      creating, by the analysis computing system, a child node of the parent node for the portion that contains the set of measurements of the anomalous output without processing other portions that do not contain the set of measurements of the anomalous output, wherein the child node divides the portion that contains the set of measurements of the anomalous output into two or more sub-portions; and
      repeating, by the analysis computing system, the creation of child nodes until a leaf node that contains the set of measurements of the anomalous output is created;
   determining, by the analysis computing system, Shapley additive explanation (SHAP) values for each node of the at least one isolation tree model; and
   determining, by the analysis computing system based on the SHAP values, one or more features that are likely to have caused the anomalous output to be anomalous.
2. The computer-implemented method of Embodiment 1, wherein creating the parent node includes:
   selecting a feature from features of the data points; and
   selecting a threshold value for the feature.
3. The computer-implemented method of Embodiment 2, wherein selecting the feature from the data points includes randomly selecting the feature from the features of the data points; and
   wherein selecting the threshold value for the features includes randomly selecting the threshold value between a minimum value and a maximum value for the feature.
4. The computer-implemented method of Embodiment 3, wherein building at least one isolation tree model includes building a plurality of isolation tree models and combining them to create an isolation forest.
5. The computer-implemented method of Embodiment 1, wherein the manufacturing process is a semiconductor manufacturing process, and wherein the anomalous output is a wafer.
6. The computer-implemented method of Embodiment 1, wherein retrieving sets of measurements of previous outputs includes:
   retrieving sets of measurements of previous outputs that are assumed to not be anomalous.
7. The computer-implemented method of Embodiment 1, wherein retrieving sets of measurements of previous outputs includes:
   retrieving sets of measurements of previous outputs that match at least one feature of set of measurements of the anomalous output.
8. A non-transitory computer-readable medium having computer-executable instructions stored thereon that, in response to execution by one or more processors of a computing system, cause the computing system to perform actions of a method as recited in any one of Embodiment 1 to Embodiment 7.
9. A computing system configured to perform a method as recited in any one of Embodiment 1 to Embodiment 7.

### Additional Examples II

1. A method of associating an anomalous output of a semiconductor manufacturing process with a manufacturing attribute of the manufacturing process, the method comprising:
   identifying the anomalous output among a plurality of outputs at a process step in the manufacturing process;
   receiving manufacturing attributes associated with each of the plurality of outputs including the anomalous output; and
   building, using a machine learning model, at least one isolation tree model comprising a plurality of parent nodes each corresponding to a split condition of one of the manufacturing attributes and a leaf node corresponding to the anomalous output,
   wherein each of the parent nodes of the at least one isolation tree model is associated with a manufacturing attribute directly leading to the anomalous output.
2. The method of Embodiment 1, wherein none of the parent nodes are associated with manufacturing attributes that are not directly leading to the anomalous output.
3. The method of Embodiment 1, wherein building each isolation tree model comprises:
   creating two or more parent nodes based on a comparison of a first measurement of the manufacturing attributes to a threshold;
   omitting from further consideration those of the two or more parent nodes that do not contain the first measurement;
   creating two or more child nodes from a remaining parent node of the two or more parent nodes based on a comparison of a subsequent measurement of the manufacturing attributes to a subsequent threshold;
   omitting from further consideration those of the two or more child nodes that do not contain the subsequent measurement; and
   repeating creation of child nodes until all measurements in the manufacturing attributes are associated with a node of the isolation tree model; and
   wherein the method further comprises determining one or more features that are likely to be associated with manufacturing attributes that are associated with the anomalous output based on the at least one isolation tree model.
4. The method of Embodiment 1, wherein identifying the anomalous output comprises identifying based on a physical attribute or an electrical attribute measured using a sensor installed on a metrology or test equipment.
5. The method of Embodiment 1, wherein the split condition of each of the manufacturing attributes is randomly determined by the machine learning model.
6. The method of Embodiment 1, wherein the plurality of outputs includes previous outputs at the process step.
7. The method of Embodiment 6, wherein the previous outputs are associated with manufacturing attributes assumed to not be anomalous output.
8. The method of Embodiment 3, wherein determining the one or more features that are likely to be associated with manufacturing attributes that are associated with the anomalous output comprises analyzing Shapley additive explanation (SHAP) values for the remaining parent node and each remaining child node.
9. The method of Embodiment 3, wherein the threshold and each subsequent threshold used in the creation of child nodes is randomly generated.
10. The method of Embodiment 3, wherein the at least one isolation tree model is plurality of isolation tree models forming an isolation forest; and
   wherein determining the one or more features that are likely to be associated with manufacturing attributes that are associated with the anomalous output is based on the isolation forest.
11. The method of Embodiment 10, wherein the two or more parent nodes of each of the plurality of isolation tree models forming the isolation forest are based on a randomly determined measurements of the manufacturing attributes
12. The method of Embodiment 1, wherein the anomalous output is a semiconductor wafer.
13. The method accruing to any one of the above Embodiments, wherein the method is further according to any one of the Embodiments in Additional Example I.

### Additional Examples III

1. Non-transitory computer readable storage media storing instructions that when executed by a system of one or more processors, cause the one or more processors to:
   identify anomalous output among a plurality of outputs at a process step in a semiconductor manufacturing process;
   receive manufacturing attributes associated with each of the plurality of outputs including the anomalous output; and
   build, using a machine learning model, at least one isolation tree model comprising a plurality of parent nodes each corresponding to a split condition of one of the manufacturing attributes and a leaf node corresponding to the anomalous output,
   wherein each of the parent nodes of the at least one isolation tree model is associated with a manufacturing attribute directly leading to the anomalous output.
2. The non-transitory computer readable storage media of Embodiment 1, wherein none of the parent nodes are associated with manufacturing attributes that are not directly leading to the anomalous output.
3. The non-transitory computer readable storage media of Embodiment 1, wherein to build each isolation tree model the instructions cause the one or more processors to:
   create two or more parent nodes based on a comparison of a first measurement of the manufacturing attributes to a threshold;
   omit from further consideration those of the two or more parent nodes that do not contain the first measurement;
   create two or more child nodes from a remaining parent node of the two or more parent nodes based on a comparison of a subsequent measurement of the manufacturing attributes to a subsequent threshold;
   omit from further consideration those of the two or more child nodes that do not contain the subsequent measurement; and
   repeat creation of child nodes until all measurements in the manufacturing attributes are associated with a node of the isolation tree model; and
   wherein the instructions further cause the one or more processors to determine one or more features that are likely to be associated with manufacturing attributes that are associated with the anomalous output based on the at least one isolation tree model.
4. The non-transitory computer readable storage media of Embodiment 1, wherein to identify the anomalous output the instructions cause the one or more processors to identify based on a physical attribute or an electrical attribute measured using a sensor installed on a metrology or test equipment.
5. The non-transitory computer readable storage media of Embodiment 1, wherein the split condition of each of the manufacturing attributes is randomly determined by the machine learning model.
6. The non-transitory computer readable storage media of Embodiment 1, wherein the plurality of outputs includes previous outputs at the process step.
7. The non-transitory computer readable storage media of Embodiment 6, wherein the previous outputs are associated with manufacturing attributes assumed to not be anomalous output.
8. The non-transitory computer readable storage media of Embodiment 3, wherein to determine the one or more features that are likely to be associated with manufacturing attributes that are associated with the anomalous output the instructions cause the one or more processors to analyze Shapley additive explanation (SHAP) values for the remaining parent node and each remaining child node.
9. The non-transitory computer readable storage media of Embodiment 3, wherein the threshold and each subsequent threshold used in the creation of child nodes is randomly generated.
10. The non-transitory computer readable storage media of Embodiment 3, wherein the at least one isolation tree model is plurality of isolation tree models forming an isolation forest; and
   wherein determining the one or more features that are likely to be associated with manufacturing attributes that are associated with the anomalous output is based on the isolation forest.
11. The non-transitory computer readable storage media of Embodiment 10, wherein the two or more parent nodes of each of the plurality of isolation tree models forming the isolation forest are based on a randomly determined measurements of the manufacturing attributes
12. The non-transitory computer readable storage media of Embodiment 1, wherein the anomalous output is a semiconductor wafer.
13. The non-transitory computer readable storage media accruing to any one of the above Embodiments, wherein the non-transitory computer readable storage media is further according to any one of the Embodiments in Additional Example I.

### Additional Examples IV

1. A system for associating an anomalous output of a semiconductor manufacturing process with a manufacturing attribute of the manufacturing process, the system comprising:
   one or more processor; and
   non-transitory computer readable storage media storing instructions that when executed by the one or more processors, cause the one or more processors to:
      identify anomalous output among a plurality of outputs at a process step in a semiconductor manufacturing process;
      receive manufacturing attributes associated with each of the plurality of outputs including the anomalous output; and
      build, using a machine learning model, at least one isolation tree model comprising a plurality of parent nodes each corresponding to a split condition of one of the manufacturing attributes and a leaf node corresponding to the anomalous output,
   wherein each of the parent nodes of the at least one isolation tree model is associated with a manufacturing attribute directly leading to the anomalous output.
2. The system of Embodiment 1, wherein none of the parent nodes are associated with manufacturing attributes that are not directly leading to the anomalous output.
3. The system of Embodiment 1, wherein to build each isolation tree model the instructions cause the one or more processors to:
   create two or more parent nodes based on a comparison of a first measurement of the manufacturing attributes to a threshold;
   omit from further consideration those of the two or more parent nodes that do not contain the first measurement;
   create two or more child nodes from a remaining parent node of the two or more parent nodes based on a comparison of a subsequent measurement of the manufacturing attributes to a subsequent threshold;
   omit from further consideration those of the two or more child nodes that do not contain the subsequent measurement; and
   repeat creation of child nodes until all measurements in the manufacturing attributes are associated with a node of the isolation tree model; and
   wherein the instructions further cause the one or more processors to determine one or more features that are likely to be associated with manufacturing attributes that are associated with the anomalous output based on the at least one isolation tree model.
4. The system of Embodiment 1, wherein to identify the anomalous output the instructions cause the one or more processors to identify based on a physical attribute or an electrical attribute measured using a sensor installed on a metrology or test equipment.
5. The system of Embodiment 1, wherein the split condition of each of the manufacturing attributes is randomly determined by the machine learning model.
6. The system of Embodiment 1, wherein the plurality of outputs includes previous outputs at the process step.
7. The system of Embodiment 6, wherein the previous outputs are associated with manufacturing attributes assumed to not be anomalous output.
8. The system of Embodiment 3, wherein to determine the one or more features that are likely to be associated with manufacturing attributes that are associated with the anomalous output the instructions cause the one or more processors to analyze Shapley additive explanation (SHAP) values for the remaining parent node and each remaining child node.
9. The system of Embodiment 3, wherein the threshold and each subsequent threshold used in the creation of child nodes is randomly generated.
10. The system of Embodiment 3, wherein the at least one isolation tree model is plurality of isolation tree models forming an isolation forest; and
   wherein determining the one or more features that are likely to be associated with manufacturing attributes that are associated with the anomalous output is based on the isolation forest.
11. The system of Embodiment 10, wherein the two or more parent nodes of each of the plurality of isolation tree models forming the isolation forest are based on a randomly determined measurements of the manufacturing attributes
12. The system of Embodiment 1, wherein the anomalous output is a semiconductor wafer.
13. The system accruing to any one of the above Embodiments, wherein the system is further according to any one of the Embodiments in Additional Example I.

While illustrative embodiments have been illustrated and described, it will be appreciated that various changes can be made therein without departing from the spirit and scope of the invention.

Unless the context clearly requires otherwise, throughout the description and the embodiments, the words “comprise,” “comprising,” “include,” “including,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a measurement error.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states.

The teachings provided herein can be applied to other systems, not necessarily the systems described above. The elements and acts of the various embodiments described above can be combined to provide further embodiments. The acts of the methods discussed herein can be performed in any order as appropriate. Moreover, the acts of the methods discussed herein can be performed serially or in parallel, as appropriate.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the form of the methods and systems described herein may be made without departing from the spirit of the disclosure. For example, while the disclosed embodiments are presented in given arrangements, alternative embodiments may perform similar functionalities with different components and/or circuit topologies, and some elements may be deleted, moved, added, subdivided, combined, and/or modified. Each of these elements may be implemented in a variety of different ways as suitable. Any suitable combination of the elements and acts of the various embodiments described above can be combined to provide further embodiments. The accompanying claims and their equivalents are intended to cover such forms or modifications as would fall within the scope and spirit of the disclosure. Accordingly, the scope of the present inventions is defined by reference to the claims.

1. A method of associating an anomalous output of a semiconductor manufacturing process with a manufacturing attribute of the manufacturing process, the method comprising:
identifying the anomalous output among a plurality of outputs at a process step in the manufacturing process;
receiving manufacturing attributes associated with each of the plurality of outputs including the anomalous output; and
building, using a machine learning model, at least one isolation tree model comprising a plurality of parent nodes each corresponding to a split condition of one of the manufacturing attributes and a leaf node corresponding to the anomalous output,
wherein each of the parent nodes of the at least one isolation tree model is associated with a manufacturing attribute directly leading to the anomalous output.

2. The method of claim 1, wherein none of the parent nodes are associated with manufacturing attributes that are not directly leading to the anomalous output.

3. The method of claim 1, wherein building each isolation tree model comprises:
creating two or more parent nodes based on a comparison of a first measurement of the manufacturing attributes to a threshold;
omitting from further consideration those of the two or more parent nodes that do not contain the first measurement;
creating two or more child nodes from a remaining parent node of the two or more parent nodes based on a comparison of a subsequent measurement of the manufacturing attributes to a subsequent threshold;
omitting from further consideration those of the two or more child nodes that do not contain the subsequent measurement; and
repeating creation of child nodes until all measurements in the manufacturing attributes are associated with a node of the isolation tree model; and
wherein the method further comprises determining one or more features that are likely to be associated with manufacturing attributes that are associated with the anomalous output based on the at least one isolation tree model.

4. The method of claim 1, wherein identifying the anomalous output comprises identifying based on a physical attribute or an electrical attribute measured using a sensor installed on a metrology or test equipment.

5. The method of claim 1, wherein the split condition of each of the manufacturing attributes is randomly determined by the machine learning model.

6. The method of claim 1, wherein the plurality of outputs includes previous outputs at the process step.

7. The method of claim 6, wherein the previous outputs are associated with manufacturing attributes assumed to not be anomalous output.

8. The method of claim 3, wherein determining the one or more features that are likely to be associated with manufacturing attributes that are associated with the anomalous output comprises analyzing Shapley additive explanation (SHAP) values for the remaining parent node and each remaining child node.

9. The method of claim 3, wherein the threshold and each subsequent threshold used in the creation of child nodes is randomly generated.

10. The method of claim 3, wherein the at least one isolation tree model is plurality of isolation tree models forming an isolation forest; and
wherein determining the one or more features that are likely to be associated with manufacturing attributes that are associated with the anomalous output is based on the isolation forest.

11. The method of claim 10, wherein the two or more parent nodes of each of the plurality of isolation tree models forming the isolation forest are based on a randomly determined measurements of the manufacturing attributes.

12. The method of claim 1, wherein the anomalous output is a semiconductor wafer.

13. Non-transitory computer readable storage media storing instructions that when executed by a system of one or more processors, cause the one or more processors to:
identify anomalous output among a plurality of outputs at a process step in a semiconductor manufacturing process;
receive manufacturing attributes associated with each of the plurality of outputs including the anomalous output; and
build, using a machine learning model, at least one isolation tree model comprising a plurality of parent nodes each corresponding to a split condition of one of the manufacturing attributes and a leaf node corresponding to the anomalous output,
wherein each of the parent nodes of the at least one isolation tree model is associated with a manufacturing attribute directly leading to the anomalous output.

14. The non-transitory computer readable storage media of claim 13, wherein none of the parent nodes are associated with manufacturing attributes that are not directly leading to the anomalous output.

15. The non-transitory computer readable storage media of claim 13, wherein to build each isolation tree model the instructions cause the one or more processors to:
create two or more parent nodes based on a comparison of a first measurement of the manufacturing attributes to a threshold;
omit from further consideration those of the two or more parent nodes that do not contain the first measurement;
create two or more child nodes from a remaining parent node of the two or more parent nodes based on a comparison of a subsequent measurement of the manufacturing attributes to a subsequent threshold;
omit from further consideration those of the two or more child nodes that do not contain the subsequent measurement; and
repeat creation of child nodes until all measurements in the manufacturing attributes are associated with a node of the isolation tree model; and
wherein the instructions further cause the one or more processors to determine one or more features that are likely to be associated with manufacturing attributes that are associated with the anomalous output based on the at least one isolation tree model.

16. The non-transitory computer readable storage media of claim 13, wherein to identify the anomalous output the instructions cause the one or more processors to identify based on a physical attribute or an electrical attribute measured using a sensor installed on a metrology or test equipment.

17. The non-transitory computer readable storage media of claim 13, wherein the split condition of each of the manufacturing attributes is randomly determined by the machine learning model.

18. The non-transitory computer readable storage media of claim 13, wherein the plurality of outputs includes previous outputs at the process step.

19. The non-transitory computer readable storage media of claim 18, wherein the previous outputs are associated with manufacturing attributes assumed to not be anomalous output.

20. The non-transitory computer readable storage media of claim 15, wherein to determine the one or more features that are likely to be associated with manufacturing attributes that are associated with the anomalous output the instructions cause the one or more processors to analyze Shapley additive explanation (SHAP) values for the remaining parent node and each remaining child node.

21. The non-transitory computer readable storage media of claim 15, wherein the threshold and each subsequent threshold used in the creation of child nodes is randomly generated.

22. The non-transitory computer readable storage media of claim 15, wherein the at least one isolation tree model is plurality of isolation tree models forming an isolation forest; and
wherein determining the one or more features that are likely to be associated with manufacturing attributes that are associated with the anomalous output is based on the isolation forest.

23. The non-transitory computer readable storage media of claim 22, wherein the two or more parent nodes of each of the plurality of isolation tree models forming the isolation forest are based on a randomly determined measurements of the manufacturing attributes.

24. The non-transitory computer readable storage media of claim 13, wherein the anomalous output is a semiconductor wafer.

25.-36. (canceled)
